(19) United States
(12) Patent Application Publication
(10) Pub. No.: US 2013/0061132 A1
(43) Pub. Date: Mar. 7, 2013

(54) SYSTEM AND METHOD FOR WEB PAGE SEGMENTATION USING ADAPTIVE THRESHOLD COMPUTATION

(71) Applicants: Li-Wei Zheng, Beijing (CN); Jian-Ming Jin, Beijing (CN); Suk Hwan Lim, Mountain View, CA (US); Yuhong Xiong, Beijing (CN); Jerry J. Liu, Sunnyvale, CA (US)

(72) Inventors: Li-Wei Zheng, Beijing (CN); Jian-Ming Jin, Beijing (CN); Suk Hwan Lim, Mountain View, CA (US); Yuhong Xiong, Beijing (CN); Jerry J. Liu, Sunnyvale, CA (US)

(21) Appl. No.: 13/696,625

(22) PCT Filed: May 19, 2010
(86) PCT No.: PCT/CN2010/072910

§ 371 Date: Nov. 7, 2012

(51) Int. Cl. G06F 17/00

(52) U.S. Cl. 715/234

(57) ABSTRACT

A system and method for an adaptive threshold Web Page segmenting is disclosed. In one embodiment, a method performed by a physical computing system having one or more processors for segmenting a Web page including a plurality of nodes includes parsing content in the Web page into the plurality of nodes using the physical computing system, obtaining feature values between each pair of nodes using the physical computing system, estimating an adaptive threshold value using the obtained feature values using the physical computing system, and segmenting the Web page by comparing the feature values associated with each pair of nodes with the estimated adaptive threshold value.

### BACKGROUND

Web pages provide an inexpensive and convenient way to make information available to its customers. However, as the inclusion of multimedia content, embedded advertising, and online services becoming increasingly more prevalent in modern Web pages, the Web pages themselves have become substantially more complex. For example, in addition to their main content, many Web pages display auxiliary content such as background imagery, advertisements, navigation menus, and/or links to additional content.

It is often the case that owners or customers of Web pages wish to utilize or adapt only a portion of the information presented in a Web page. For instance, a user/customer may desire to print a physical copy of an Internet article without reproducing any of the irrelevant content on the Web page containing the article. Similarly, the owner of a Web page may wish to adapt a Web page into another document, such as a marketing brochure, without including content in the Web page that is superfluous to the new document. Such uses of only a portion of the content presented in a Web page can require tedious effort on the part of a user to distinguish among the different types of content on the Web page and retrieve only the desired content. Finding a desired portion of the Web page is one of the important applications of Web page segmentation.

Typically, Web page segmentation divides the Web page into segments. Each segment in a Web page serves as a functional area, such as a title, a main content, an advertisement, and a navigation bar. Web page segmentation has many applications. Exemplary applications include, information extraction, support for semantic Web, topic distillation, informative content retrieval, duplicate detection, repurposing of Web page documents, re-layout for mobile screens, and Web printing.

Segmenting a Web page is typically an important function in Web printing and automated re-publishing of Web-contents. However, both the Web page layouts and the presentation styles in Web pages are very complex and diverse. This can make it difficult to provide a common solution for segmenting that works for all Web pages. Most of the current techniques for Web page segmentation are based on Document Object Model (DOM) tree to analyze the Hypertext Markup Language (HTML) structure. Some of the remaining current techniques for Web page segmentation use visual information of Web page layouts after they are rendered by the browser engine. However, these techniques are rule-based with predefined parameters and the thresholds obtained using these techniques can be fixed and may not be fully adaptable to the varying Web page layouts. Further, it can be difficult to control the segmentation granularity using conventional techniques. Furthermore, the conventional techniques can result in inconsistent granularity for different Web pages.

### BRIEF DESCRIPTION OF THE DRAWINGS

Various embodiments are described herein with reference to the drawings, wherein:

FIG. 1 illustrates a computer implemented flow diagram of an exemplary method for Web page segmentation using adaptive threshold computation;

FIG. 2A illustrates obtaining distance between bounding boxes in a Web page, according to one embodiment;

FIG. 2B illustrates obtaining overlap between bounding boxes in a Web page, according to one embodiment;

FIG. 3 illustrates a graph used in obtaining adaptive threshold, according to one embodiment;

FIG. 4A illustrates a screenshot of an illustrative web browser displaying a Web page that can be segmented into a plurality of functional blocks, in the context of the present invention;

FIG. 4B illustrates a screenshot of an exemplary Web page parsed into plurality of nodes before segmentation, in the context of the present invention;

FIG. 4C illustrates screenshot of a segmented Web page obtained using the obtained adaptive threshold and neighbor blocks combiner, according to one embodiment;

FIG. 5 is a block diagram of a Web page segmenting module, according to one embodiment;

FIG. 6 illustrates a block diagram of a system for segmenting a Web page using the Web page segmenting module of FIG. 5, according to one embodiment;

The drawings described herein are for illustration purposes only and are not intended to limit the scope of the present disclosure in any way.

### DETAILED DESCRIPTION

A system and method for Web page segmentation using an adaptive threshold computation is disclosed. In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined by the appended claims.

The Web page segmentation process described herein segments a Web page into a number of meaningful functional or logical blocks. These functional blocks can be advantageously used to, for example, extract only the content from a Web page that is useful to a specific application. In addition, these blocks can be advantageously used to perform, for example, web printing, automated re-publishing of Web contents and the like.

In the document, the term “Web page” refers to a document, such as blogs, emails, news and recipes and so on, that can be retrieved from a server over a network connection and viewed in a Web browser application. Also, the term “node”, such as atom, refers to one of a plurality of coherent areas in a Web page that are homogeneous in property and do not have children in a DOM tree. The term “homogeneous” refers to characteristic of having content of the same type or property. The term “segment or block” refers to a part of the Web page or an area in the Web page that have a certain function in the document and have coherent property. Further, each segment or block includes one or more nodes. Furthermore, the term “coherent,” as applied to a node, refers to the characteristic of having content only of the similar type or property.

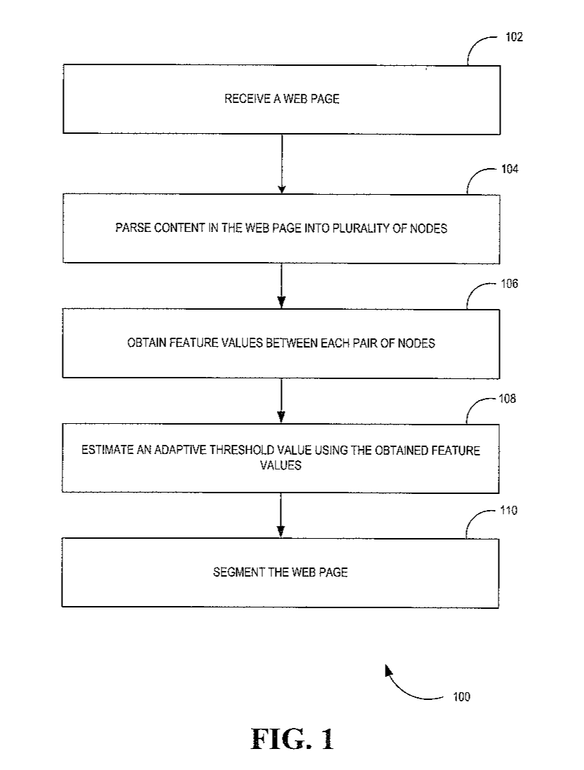

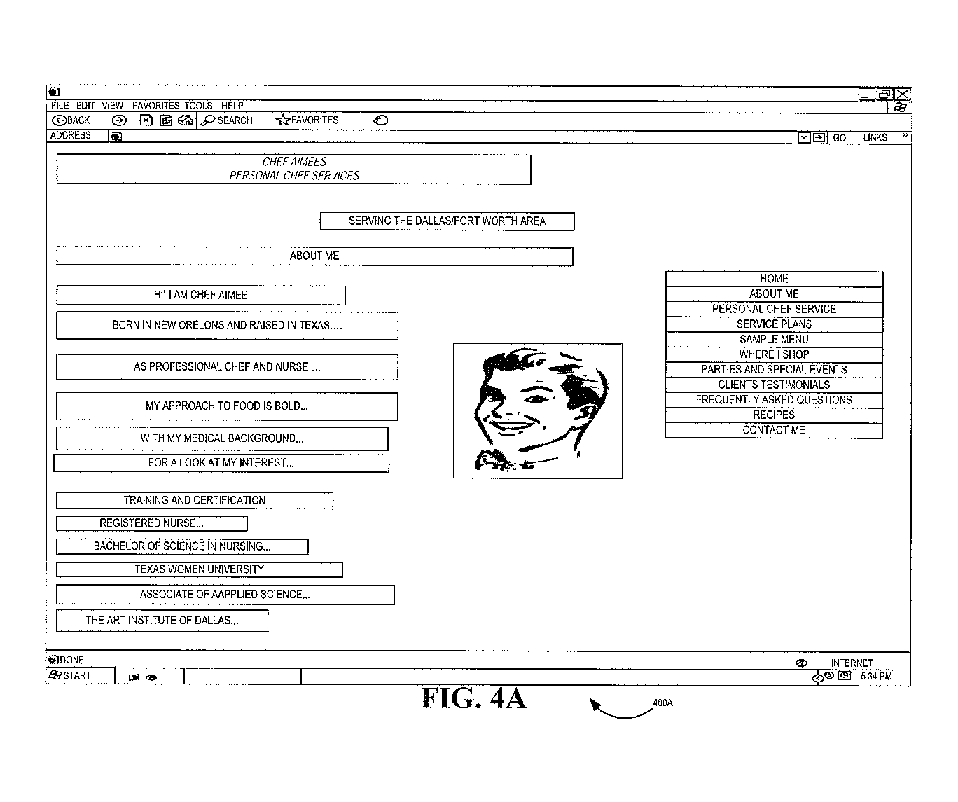

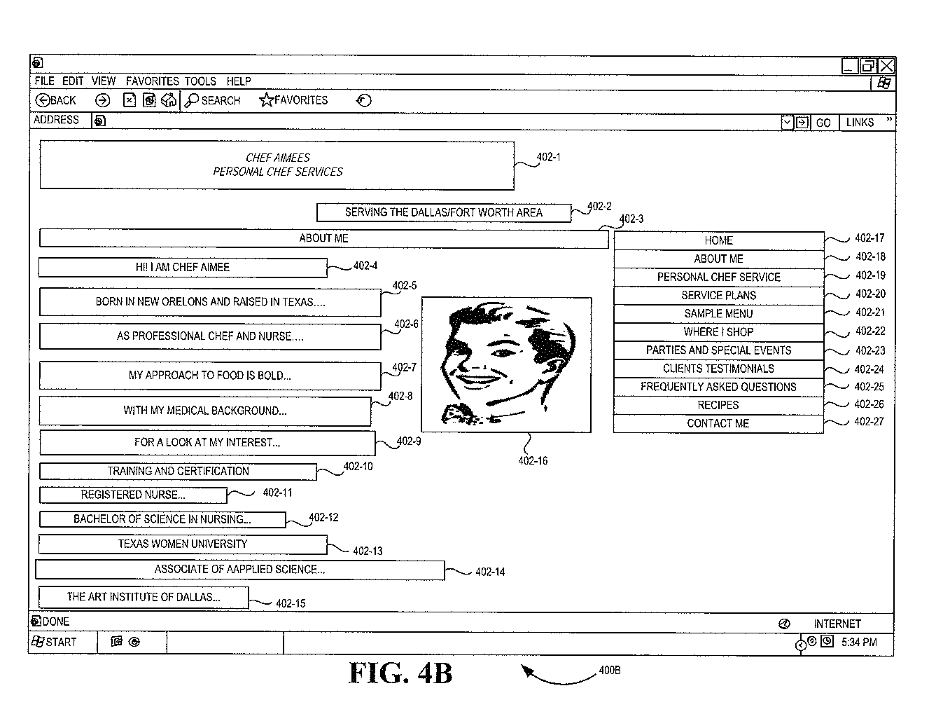

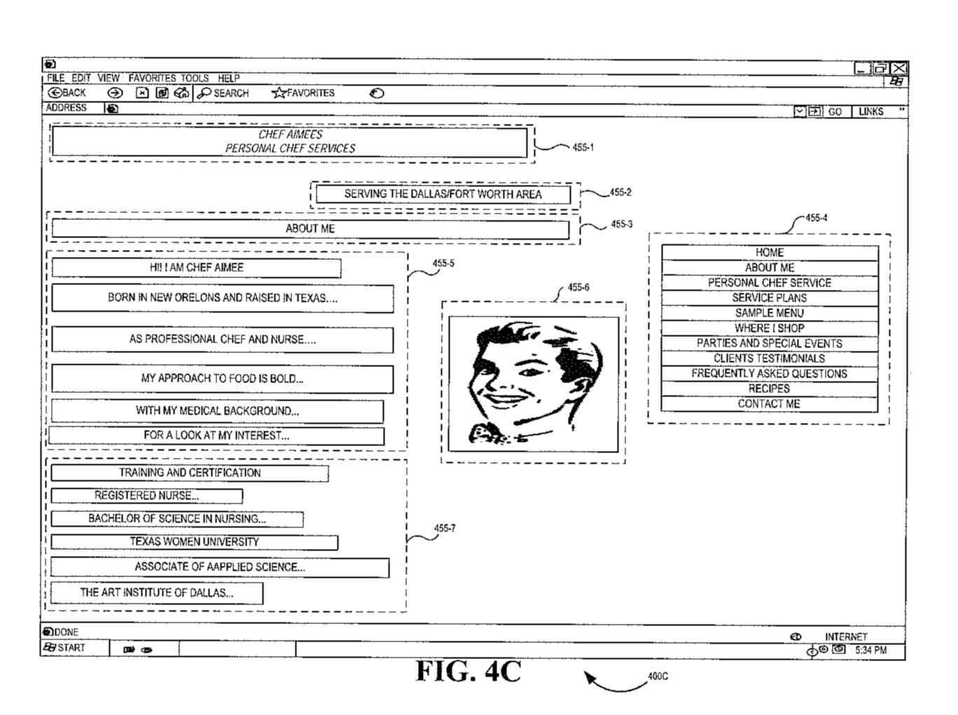

FIG. 1 illustrates a computer implemented flow diagram 100 of an exemplary method for Web page segmentation using an adaptive threshold computation, according to one embodiment. At step 102, a Web page (e.g., Web page shown in FIG. 4A) is received by a physical computing system. In one example embodiment, a URL for the Web page is received by the physical computing system. For example, the physical computing system may perform the functions of fetching the Web page from its server and rendering the Web page to determine a layout of content in the Web page. In another example embodiment, the URL may be specified by a user of the physical computing system or, alternatively, be determined automatically. The physical computing system may then request the Web page from its server over a network such as the internet using the URL.

At step 104, content in the Web page is parsed into a plurality of nodes using the physical computing system. The parsing content in the Web page into a plurality of nodes is explained with respect to FIG. 4B. In one embodiment, the nodes include atoms or areas in the Web page that are substantially homogenous in property and do not have children in the DOM tree structure associated with the Web page. Further, the atoms are visible without any user action on the rendered Web page in a browser. Furthermore, each node in the plurality of nodes is defined by a bounding box. For example, the nodes defined by the bounding boxes in the Web page include atoms selected from the group consisting of text, image, flash, list, input control, and visual separator.

At step 106, feature values between each pair of nodes are obtained using the physical computing system. In one example embodiment, the feature values between each pair of nodes are obtained by obtaining feature values between each pair of bounding boxes using the physical computing system. Further, obtaining feature values between each pair of the bounding boxes includes obtaining spatial feature values between each pair of the bounding boxes. Furthermore, obtaining spatial feature values between each pair of the bounding boxes includes obtaining position information of each atom, and obtaining the spatial feature values between each pair of the bounding boxes using the position information associated with each atom.

For example, the position information is selected from the group consisting of left coordinate of the bounding box, top coordinated of the bounding box, width of the bounding box and height of the bounding box. In other words, the bounding box of each atom represents position information of the respective atom.

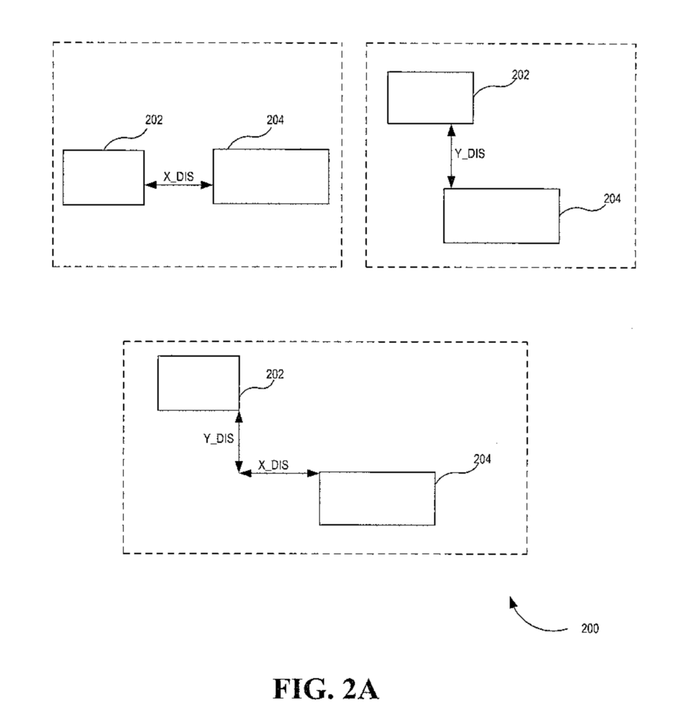

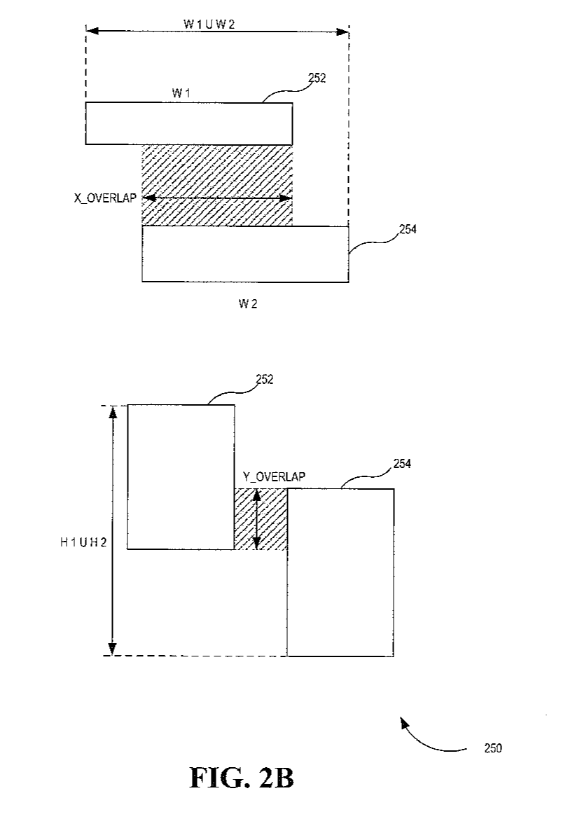

In one example embodiment, distance values and overlap values are obtained between each pair of the bounding boxes using the position information of each atom. In one embodiment, the feature values between each pair of nodes include the distance values between each pair of the bounding boxes and overlap values between each pair of the bounding boxes. In other words, the spatial feature values are selected from the group consisting of the distance values obtained between each pair of the bounding boxes and the overlap values obtained between each pair of the bounding boxes. The computation of distance values and the overlap values are explained in detail with respect to FIG. 2A and FIG. 2B.

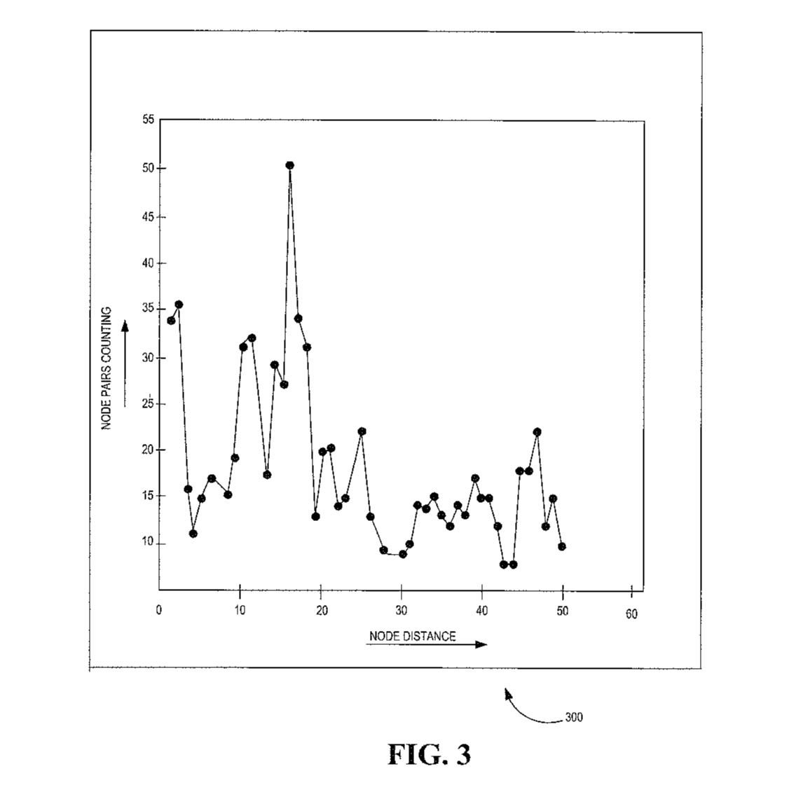

At step 108, an adaptive threshold value is estimated using the obtained feature values by the physical computing system. In these embodiments, a spatial distribution (e.g., as shown in FIG. 3) based on characteristics of the obtained spatial feature values is computed. Further, the adaptive threshold value is estimated using the computed spatial distribution.

In one example embodiment, the adaptive threshold value is estimated as a fixed percentile of the computed spatial distribution. For example, the adaptive threshold value is chosen such that it includes about 50% of the computed spatial distribution. In another example embodiment, the adaptive threshold value is estimated as combination of mean and standard deviation values of the computed spatial distribution. In yet another example embodiment, the adaptive threshold value is estimated by performing clustering based on the spatial distribution of the obtained spatial feature values. In yet another example embodiment, the adaptive threshold value is estimated based on the number of segments in the Web page.

At step 110, the Web page is segmented (e.g., as shown in FIG. 4C) by comparing the feature values associated with each pair of nodes with the estimated adaptive threshold value. In these embodiments, a pair of nodes is merged into a same segment in each iteration if the feature value of the pair of nodes meets a threshold condition. Further, the iterations are terminated when there are no pairs of nodes match the threshold condition. In other words, the input nodes are grouped into segments by performing the above mentioned steps. As a result, the nodes in one segment are spatial consistent. Further, the above mentioned steps are explained in detail with respect to FIG. 2 to FIG. 4 as follows.

FIG. 2A is an exemplary diagram 200 illustrating obtaining distance between bounding boxes in a Web page, according to one embodiment. Particularly, FIG. 2A illustrates a pair of bounding boxes 202 and 204. In one embodiment, each pair of bounding boxes 202 and 204 represents position information of the respective atom or node.

In one embodiment, the spatial feature values between the pair of bounding boxes 202 and 204 include the distance values obtained between the pair of the bounding boxes 202 and 204 and the overlap values obtained between the pair of the bounding boxes 202 and 204. In one example embodiment, the distance between the pair of the bounding boxes 202 and 204 is computed using the two dimensional coordinates (i.e., x and y coordinates).

As shown in FIG. 2A, the distance between the pair of bounding boxes 202 and 204 consists of two parts, i.e., distance along the x-coordinate and along y-coordinate. The distance between the pair of bounding boxes 202 and 204 is computed using:

D=X_DIS+Y_DIS

Where X_DIS is the distance between the pair of bounding boxes 202 and 204 in x direction, Y_DIS is the distance between the pair of bounding boxes 202 and 204 in y direction.

Further, the distance between the pair of bounding boxes 202 and 204 in x direction (X_DIS) is computed using

X_DIS=MAX(MAX (box1.1eft, box2.left)−MIN(box1.right, box2.right), 0)
Where box1.left is the left coordinate of the bounding box 202, box2.1eft is the left coordinate of the bounding box 204, box1.right is the right coordinate of the bounding box 202, and box2.right is the right coordinate of the bounding box 204.

Furthermore, the distance between the pair of bounding boxes 202 and 204 in y direction (Y_DIS) is computed using

Y_DIS=MAX(MAX(box1.top, box2.top)−MIN(box1.bottom, box2.bottom), 0)
Where box1.top is the top coordinate of the bounding box 202, box2,top is the top coordinate of the bounding box 204, box1.bottom is the bottom coordinate of the bounding box 202, and box2,bottom is the bottom coordinate of the bounding box 204.

Therefore, the distance between the pair of bounding boxes 202 and 204 is the sum of the distance between the pair of bounding boxes 202 and 204 in x direction (X_DIS) and the distance between the pair of bounding boxes 202 and 204 in y direction (Y_DIS).

FIG. 2B is an exemplary diagram 250 illustrating obtaining overlap between bounding boxes in a Web page, according to one embodiment. Particularly, FIG. 2B illustrates a pair of bounding boxes 252 and 254. In one embodiment, each pair of bounding boxes 252 and 254 represents position information of the respective atom or node.

As mentioned above, the spatial feature values between the pair of bounding boxes 252 and 254 include the distance values obtained between the pair of the bounding boxes 252 and 254 and the overlap values obtained between the pair of the bounding boxes 252 and 254. In one example embodiment, the overlap between the pair of the bounding boxes 252 and 254 is computed using the two dimensional coordinates (i.e., x and y coordinates).

As shown in FIG. 2B, the overlap between the pair of bounding boxes 252 and 254 consists of two types, i.e., overlap along the x-coordinate and along y-coordinate. In other words, the overlap between the pair of bounding boxes 252 and 254 includes either horizontal overlap (i.e., x overlap) or vertical overlap (i.e., y overlap).

As shown in FIG. 2B, if the pair of bounding boxes 252 and 254 has intersection in x-coordinate projection, the Block Overlap Rate is computed using:

X_OVERLAP_RATE=X_OVERLAP/(w1 ∪ w2)
Where X_OVERLAP is the intersection of x projection coordinate, and w1 ∪ w2 is the union range of width of the bounding boxes 252 and 254,

Further, if the pair of bounding boxes 252 and 254 has intersection in y-coordinate projection, the Block Overlap Rate is computed using:

Y_OVERLAP_RATE=Y_OVERLAP/(h1 ∪ h2)

Where Y_OVERLAP is the intersection of y projection coordinate, and h1 ∪ h2 is the union range of height of the bounding boxes 252 and 254.

In accordance with the above mentioned embodiments with respect to FIG. 2A and 2B, the distance and overlap rate values are calculated for each pair of bounding boxes. The pairs of bounding boxes are selected such that two bounding boxes are adjacent and meet an overlap rate condition. In one example embodiment, two bounding boxes are adjacent means that there are no other bounding boxes between them. In other words, two bounding boxes are said to be adjacent if there are no bounding boxes having intersection with their X overlap area and Y overlap area. As shown in FIG. 2B, the X/Y overlap area is shown by shaded lines.

The spatial distribution of the distance values between each pair of bounding boxes is obtained from the bounding box pairs. Further, different Web pages have different spatial distributions of the distance values. In one example embodiment, a peak value of the spatial distribution can be chosen as the adaptive threshold value for the Web page automatically. In another example embodiment, the value can also be adjusted by a user. In yet another example embodiment, if rough segmentation granularity is needed, other extreme values of the spatial distribution can also be selected as the adaptive threshold values. The computation of spatial distribution using characteristics of the distance values and the overlap values of the Web page is explained in detail with respect to FIG. 3.

FIG. 3 illustrates a graph 300 used in obtaining adaptive threshold, according to one embodiment. Particularly, FIG. 3 illustrates distribution of distance values computed between each pair of bounding boxes. The x-axis represents the node distance, and the y-axis represents the node pairs counting corresponding to the node distance in the x-axis. In these embodiments, the node distance refers to the distance between each pair of bounding boxes and the node pairs counting refers to the number of bounding box pairs corresponding to the distance value in the x-axis.

As shown in FIG. 3, the node distance value corresponding to the maximal node pairs counting is 16. In other words, at the node distance value of 16, the number of node pairs is 45 which is the maximum node pair count as shown in the bounding box distance distribution graph 300. Therefore, the adaptive threshold value for the Web page is automatically selected as 16 which is the peak value of the spatial distribution.

In another exemplary implementation, if fine granularity (i.e., more segments) is required, the extreme node distance values such as 11 and 14 can be selected as candidates for the adaptive threshold value. In yet another exemplary implementation, if rough granularity (i.e., fewer segments) is needed, the extreme node distance values of 21, 25 and 47 can be selected as the adaptive threshold candidates.

In accordance with the above described embodiments with respect to FIG. 3, various methods for estimating the adaptive threshold value based on the computed spatial distribution are explained as follows.

In one exemplary method, the adaptive threshold value is selected as a fixed percentile of the computed spatial distribution. For example, the adaptive threshold value is selected such that it covers 50% of the spatial distribution. This method provides a better result than choosing a fixed threshold as it adapts to the spatial distribution.

In another exemplary method, the adaptive threshold value is estimated using a combination of the computed mean (m) and standard deviation (a) values of the spatial distribution. For example, the adaptive threshold is estimated using m−2 a

In yet another exemplary method, the adaptive threshold value is estimated by performing clustering based on the spatial distribution. In these embodiments, while determining whether to merge or not, k-means clustering can be performed, where k=2. Alternately, initial clustering with higher k may be performed first and then another step of merging clusters can be performed.

In yet another exemplary method, the method chooses a predetermined threshold value, counts a number of segments in the Web page and sets a target number of segments. Further, the adaptive threshold value is estimated by varying the predetermined threshold such that the number of segments is equal to the target number of segments.

In yet another exemplary method, the adaptive threshold value is also estimated as a combination of clustering and varying methods described above. In these embodiments, the method initially starts with clustering with higher value of k and continues to merge the clusters from the high end until the number of target segments is reached. Further, the distribution is grouped into clusters, where each cluster represents certain type of arrangements. Furthermore, the adaptive threshold value is estimated by examining this arrangement to determine if it makes sense to increase the threshold value or not.

Once the adaptive threshold value is estimated (e.g., using anyone of the above mentioned methods), the Web page is segmented by comparing the feature values (i.e., the spatial feature values such as block distance and overlap rate values) associated with each pair of nodes with the estimated adaptive threshold value. In other words, each pair of neighboring bounding boxes/nodes is merged into segments whose distance value is less than or equal to the estimated adaptive threshold. The neighboring bounding boxes or nodes refer to two blocks which meet the adjacent condition as described earlier.

In one embodiment, the merging process is done by iteration until there is no pair of bounding boxes/nodes meets the merging condition. For example, consider a set of nodes A, B, C, and D (e.g., nodes 402 4 to 402 7 as illustrated in FIG. 48) of the plurality of nodes in a Web page. Further consider that the nodes A and B form one pair of neighboring nodes, B and C form another pair and C and D form yet another pair. In iteration i, if the pair of nodes A and B meets the merging condition (e.g., distance between the pair of nodes A and B is less than or equal to the estimated adaptive threshold), then the pair of nodes A and B are merged into a first segment. Similarly, in iteration j, if the pair of nodes C and D meet the merging condition, then the pair of nodes C and D is merged into a second segment. Furthermore, in iteration k, if the pair of nodes B and C meets the merging condition, then the pair of nodes B and C are merged into a segment where all the four nodes A, B, C, and D will be merged into the same segment (e.g., segment 455-5 as illustrated in FIG. 4C). In other words, the first segment and the second segment are merged into a segment which includes all the four nodes A, B, C, and D. The nodes A, B, C, and D are grouped into one segment and are spatial consistent. FIGS. 4A-C illustrates various aspects of the process of segmenting a Web page into a plurality of functional or logical blocks outlined above.

FIG. 4A illustrates a screenshot of an illustrative web browser (400A) displaying a Web page that can be segmented into a plurality of functional blocks, in the context of the present invention.

FIG. 4B illustrates a screenshot of an exemplary Web page (400B) parsed into plurality of nodes before segmentation, in the context of the present invention. Particularly, FIG. 4B illustrates Web page parsed into the plurality of nodes (402-1 to 402-27) in consistent with the functionality described with reference to FIG. 1. As shown in FIG. 4B, these nodes (402-1 to 402-27) conform to atoms or areas in the Web page that are substantially homogenous in property and do not have children in the DOM tree structure associated with the Web page. Further, these nodes (402-1 to 402-27) are visible without any user action on the rendered Web page in a browser. The nodes (402-1 to 402-27) include text, image, flash, list, input control, and/or visual separator. Further, these nodes (402-1 to 402-27) conform to the requirements of being atomic and coherent. Additionally, the nodes (402-1 to 402-27) are collectively exhaustive and mutually exclusive, as all of the visible content from the Web page of FIG. 4A is present in the sum of the nodes (402-1 to 402-27) and no two nodes (402-1 to 402-27) share the same content.

FIG. 4C illustrates screenshot of a segmented Web page (400C) obtained using the obtained adaptive threshold and neighbor blocks combiner, according to one embodiment. Particularly, FIG. 4C illustrates segments (455-1 to 455-7) of the Web page. The nodes in the same segment are grouped together and represented with a common dotted line. For example, the nodes 402-4 to 402-9 (as shown in FIG. 4B) are merged to a segment 455-5 (as shown in FIG. 4C) based on the merging condition described above. Further, the nodes in one segment are spatially consistent.

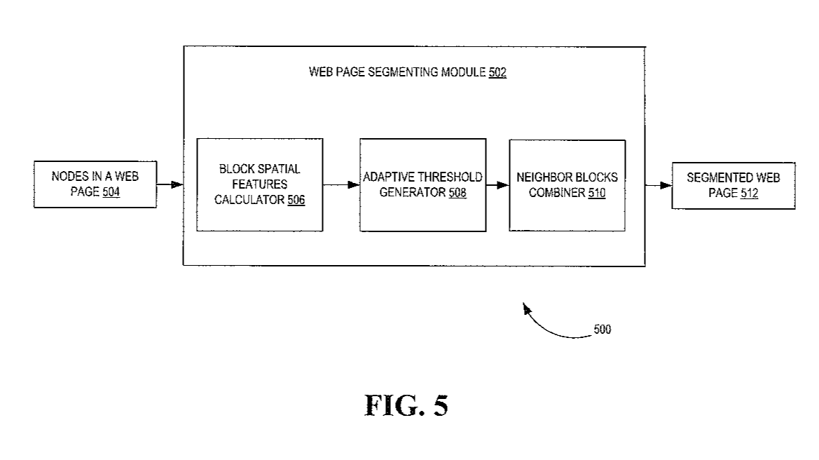

FIG. 5 is a block diagram 500 of a Web page segmenting module 502, according to one embodiment. Particularly, Web page segmenting module 502 includes a block spatial features calculator 506, an adaptive threshold generator 508, and a neighbor blocks combiner 510. Further, Arrows between the modules represent the communication and interoperability among the modules. Further, the block spatial features calculator 506, the adaptive threshold generator 508, and the neighbor blocks combiner 510 are operable to perform the above mentioned methods.

In operation, the block spatial features calculator 506 receives a plurality of nodes 504 from one Web page and obtains feature values between each pair of nodes. In one example embodiment, content in the Web page is parsed into the plurality of nodes 504 using a computer, Further, the adaptive threshold generator 508 estimates an adaptive threshold value using the obtained feature values. Furthermore, the neighbor blocks combiner 510 segments the Web page by comparing the feature values associated with each pair of nodes with the estimated adaptive threshold value. In one example embodiment, the neighbor blocks combiner 510 merges a pair of nodes into a same segment (e.g., segmented Web page 512) in each iteration if the feature value of the pair of nodes meets a threshold condition as explained above.

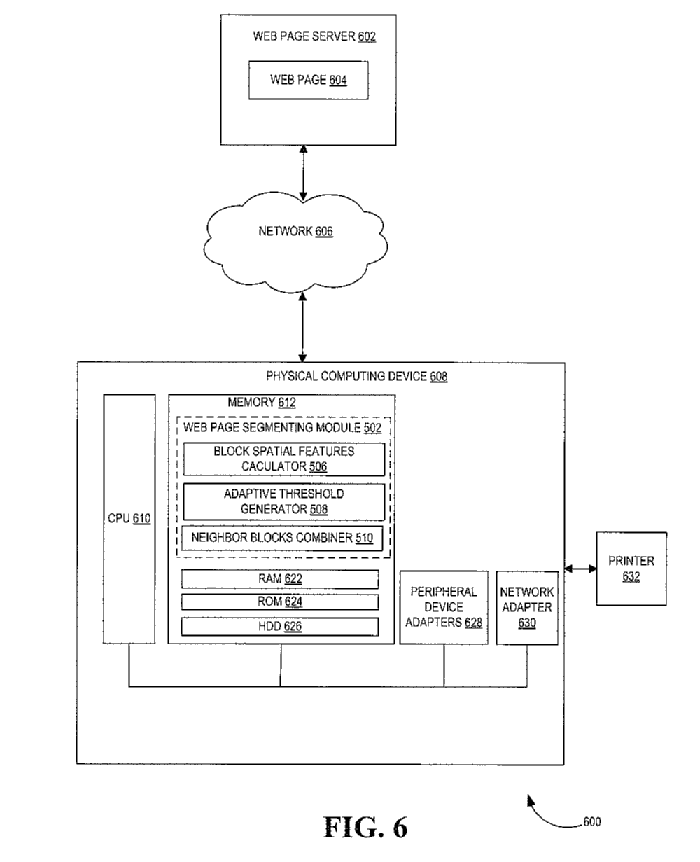

FIG. 6 illustrates a block diagram (600) of a system for segmenting a Web page using the Web page segmenting module of FIG. 5, according to one embodiment. Referring now to FIG. 6, an illustrative system (600) for segmenting a Web page into coherent functional or logical blocks includes a physical computing device (608) that has access to a Web page (604) stored by a web page server (602). In the present example, for the purposes of simplicity in illustration, the physical computing device (608) and the web page server (602) are separate computing devices communicatively coupled to each other through a mutual connection to a network (606). However, the principles set forth in the present specification extend equally to any alternative configuration in which the physical computing device (608) has complete access to a Web page (604). As such, alternative embodiments within the scope of the principles of the present specification include, but are not limited to, embodiments in which the physical computing device (608) and the web page server (602) are implemented by the same computing device, embodiments in which the functionality of the physical computing device (608) is implemented by a multiple interconnected computers (e.g., a server in a data center and a user's client machine), embodiments in which the physical computing device (608) and the web page server (602) communicate directly through a bus without intermediary network devices, and embodiments in which the physical computing device (608) has a stored local copy of the Web page (604) to be segmented.

The physical computing device (608) of the present example is a computing device configured to retrieve the Web page (604) hosted by the web page server (602) and divide the Web page (604) into multiple coherent, functional blocks. In the present example, this is accomplished by the physical computing device (608) requesting the Web page (604) from the web page server (602) over the network (606) using the appropriate network protocol (e.g., Internet Protocol (“P”)). Illustrative processes of segmenting the Web page content will be set forth in more detail below.

To achieve its desired functionality, the physical computing device (608) includes various hardware components. Among these hardware components may be at least one processing unit (610), at least one memory unit (612), peripheral device adapters (628), and a network adapter (630). These hardware components may be interconnected through the use of one or more busses and/or network connections.

The processing unit (610) may include the hardware architecture necessary to retrieve executable code from the memory unit (612) and execute the executable code. The executable code may, when executed by the processing unit (610), cause the processing unit (610) to implement at least the functionality of retrieving the Web page (604) and semantically segmenting the Web page (604) into coherent functional or logical blocks according to the methods of the present specification described below. In the course of executing code, the processing unit (610) may receive input from and provide output to one or more of the remaining hardware units.

The memory unit (612) may be configured to digitally store data consumed and produced by the processing unit (610). Further, the memory unit (612) includes the Web page segmenting module 502 of FIG. 5. Furthermore, the Web page segmenting module 502 includes a block spatial features calculator 506, an adaptive threshold generator 508, and a neighbor blocks combiner 510. The memory unit (612) may also include various types of memory modules, including volatile and nonvolatile memory. For example, the memory unit (612) of the present example includes Random Access Memory (RAM) 622, Read Only Memory (ROM) 624, and Hard Disk Drive (HDD) memory 626. Many other types of memory are available in the art, and the present specification contemplates the use of any type(s) of memory in the memory unit (612) as may suit a particular application of the principles described herein. In certain examples, different types of memory in the memory unit (612) may be used for different data storage needs. For example, in certain embodiments the processing unit (610) may boot from ROM, maintain nonvolatile storage in the HDD memory, and execute program code stored in RAM.

The hardware adapters (628, 630) in the physical computing device (608) are configured to enable the processing unit (610) to interface with various other hardware elements, external and internal to the physical computing device (608). For example, peripheral device adapters (628) may provide an interface to input/output devices to create a user interface and/or access external sources of memory storage. Peripheral device adapters (628) may also create an interface between the processing unit (610) and a printer (632) or other media output device. For example, in embodiments where the physical computing device (608) is configured to generate a document based on functional blocks extracted from the Web page's content, the physical computing device (608) may be further configured to instruct the printer (632) to create one or more physical copies of the document.

A network adapter (630) may provide an interface to the network (606), thereby enabling the transmission of data to and receipt of data from other devices on the network (606), including the web page server (602).

The above described embodiments with respect to FIG. 6 are intended to provide a brief, general description of the suitable computing environment 600 in which certain embodiments of the inventive concepts contained herein may be implemented.

As shown, the computer program includes the adaptive threshold Web page segmentation module for segmenting a Web page including a plurality of nodes. Further, the adaptive threshold Web page segmenting module 502 includes the block spatial features calculator 506 to obtain feature values between each pair of nodes, the adaptive threshold generator 508 to estimate an adaptive threshold value using the obtained feature values, and the neighbor blocks combiner 510 to segment the Web page by comparing the feature values associated with each pair of nodes with the estimated adaptive threshold value.

For example, the adaptive threshold Web page segmenting module 502 described above may be in the form of instructions stored on a non-transitory computer-readable storage medium. An article includes the non-transitory computer-readable storage medium having the instructions that, when executed by the physical computing device 608, causes the computing device 608 to perform the one or more methods described in FIGS. 1-6.

In various embodiments, the methods and systems described in FIGS. 1 through 6 may enable to select and calculate the spatial feature values (e.g., distance and/or block overlap rate between a pair of bounding boxes), which are especially representative of Web page layouts and useful for the bottom-up approach of Web page segmentation. Further, adjacency relation (I.e., adjacent condition described above) between a pair of bounding boxes is easy to implement using the above mentioned method. Furthermore, the above mentioned system is simple to construct and efficient in terms of processing time required for segmenting the Web page. Further, the above mentioned methods and systems are adaptive to different types of web pages since the adaptive threshold value is estimated by analyzing the spatial feature distribution between each pair of nodes/bounding boxes. In addition, the above mentioned methods and systems are adaptive to both the page structure as well as the user's intent, since it can be adjusted by different requirements on segmentation granularity.

Although the present embodiments have been described with reference to specific example embodiments, it will be evident that various modifications and changes may be made to these embodiments without departing from the broader spirit and scope of the various embodiments. Furthermore, the various devices, modules, analyzers, generators, and the like described herein may be enabled and operated using hardware circuitry, for example, complementary metal oxide semiconductor based logic circuitry, firmware, software and/or any combination of hardware, firmware, and/or software embodied in a machine readable medium. For example, the various electrical structure and methods may be embodied using transistors, logic gates, and electrical circuits, such as application specific integrated circuit.

What is claimed is:

1. A method performed by a physical computing system comprising at least one processor for segmenting a Web page including a plurality of nodes, comprising:
obtaining feature values between each pair of nodes using the physical computing system;
estimating an adaptive threshold value using the obtained feature values using the physical computing system; and
segmenting the Web page by comparing the feature values associated with each pair of nodes with the estimated adaptive threshold value.

2. The method of claim 1, further comprising:
parsing content in the Web page into the plurality of nodes using the physical computing system, wherein each node is defined by a bounding box.

3. The method of claim 2, wherein obtaining the feature values between each pair of nodes comprises:
obtaining feature values between each pair of bounding boxes using the physical computing system.

4. The method of claim 3, wherein the nodes comprise atoms or areas in the Web page that are substantially homogenous in property and do not have children in the DOM tree structure associated with the Web page, wherein the atoms are visible without any user action on the Web page, and wherein the atoms defined by the bounding boxes in the Web page include atoms selected from the group consisting of text, image, flash, list, input control, and visual separator.

5. The method of claim 4, wherein obtaining feature values between each pair of the bounding boxes comprises:
obtaining spatial feature values between each pair of the bounding boxes, wherein obtaining the spatial feature values between each pair of bounding boxes comprises:
obtaining position information of each atom and wherein the position information is selected from the group consisting of left coordinate of the bounding box, top coordinated of the bounding box, width of the bounding box and height of the bounding box; and
obtaining the spatial feature values between each pair of the bounding boxes using the position information associated with each atom.

6. The method of claim 5, wherein the spatial feature values are selected from the group consisting of distance values obtained between each pair of the bounding boxes and overlap values obtained between each pair of the bounding boxes.

7. The method of claim 5, wherein estimating the adaptive threshold value using the obtained spatial feature values comprises:
computing a spatial distribution based on characteristics of the obtained spatial feature values; and
estimating the adaptive threshold value using the computed spatial distribution.

8. The method of claim 7, wherein estimating the adaptive threshold value comprises a statistical value selected from the group consisting of choosing a threshold value that substantially includes about 50% of the computed spatial distribution, combination of mean and standard deviation values of the computed spatial distribution, clustering value based on distribution of the obtained spatial feature values, and counting the number of segments in the Web page.

9. A non-transitory computer-readable storage medium for segmenting a Web page including a plurality of nodes having instructions that, when executed by a computing device, cause the computing device to perform a method comprising:
obtaining feature values between each pair of nodes;
estimating an adaptive threshold value using the obtained feature values; and
segmenting the Web page by comparing the feature values associated with each pair of nodes with the estimated adaptive threshold value.

10. A system for segmenting a Web page including a plurality of nodes, comprising:
a processor; and
memory operatively coupled to the processor, wherein the memory includes a Web page segmenting module having instructions capable of:
obtaining feature values between each pair of nodes;
estimating an adaptive threshold value using the obtained feature values; and
segmenting the Web page by comparing the feature values associated with each pair of nodes with the estimated adaptive threshold value.

11. The system of claim 10, wherein content in the Web page is parsed into the plurality of nodes using a computer, wherein the plurality of nodes are inputted to the Web page segmenting module, and wherein each node is defined by a bounding box.

12. The system of claim 11, wherein obtaining the feature values between each pair of nodes comprises:
obtaining feature values between each pair of bounding boxes using the physical computing system.

13. The system of claim 12, wherein the nodes comprise atoms or areas in the Web page that are substantially homogenous in property and do not have children in the DOM tree structure associated with the Web page, wherein the atoms are visible without any user action on the Web page, and wherein the atoms defined by the bounding boxes in the Web page include atoms selected from the group consisting of text, image, flash, list, input control, and visual separator.

14. The system of claim 13, wherein obtaining feature values between each pair of the bounding boxes comprises:
obtaining spatial feature values between each pair of the bounding boxes, wherein obtaining the spatial feature values between each pair of bounding boxes comprises:
obtaining position information of each atom and wherein the position information is selected from the group consisting of left coordinate of the bounding box, top coordinated of the bounding box, width of the bounding box and height of the bounding box; and
obtaining the spatial feature values between each pair of the bounding boxes using the position information associated with each atom.

15. The system of claim 14, wherein estimating the adaptive threshold value using the obtained spatial feature values comprises:
computing a spatial distribution based on characteristics of the obtained spatial feature values; and
estimating the adaptive threshold value using the computed spatial distribution.
